(19) United States
(12) Patent Application Publication
(10) Pub. No.: US 2019/0099904 A1
(43) Pub. Date: Apr. 4, 2019

(54) Self-Extrication Fixed Tool and Sheath

(71) Applicant: James Edward Counsellor, Hawthorne, NJ (US)

(72) Inventor: James Edward Counsellor, Hawthorne, NJ (US)

(21) Appl. No.: 15/589,452

(22) Filed: May 8, 2017

(51) Int. Cl. B26B 9/02; B26B 29/02

(52) U.S. Cl. CPC B26B 9/02; B26B 3/06; B26B 29/02

(57) ABSTRACT

A tool comprising of serrations that are in the shape of an arched chisel grind and consist of individual scalloped-shaped serrations of varying pitch and gullet sizes that is secured in a heat resistant sheath by an internal spring release and catch. The tool is engaged to and disengaged from the sheath without mechanical manipulation and together allow the tool to be presented in a ready position in order to apply the serrations of the tool to self-extricate oneself from entanglement emergencies.

### CROSS-REFERENCE TO RELATED APPLICATIONS

This application claims the benefit of U.S. Provisional Patent Application No. 62/252,601, filed Nov. 9, 2015, the entire contents of which are incorporated herein by reference.

### BACKGROUND

Many case studies have documented firefighters becoming trapped or entangled in wires or cables, for example, when ceilings collapse. The entanglement often occurs in the area of the firefighter's self-contained breathing apparatus (“S.C.B.A.”). Firefighters currently may use wire cutters or other types of knives to attempt to free themselves from entanglement situations, but those methods have proven unreliable and ineffective. Similar entanglement situations may be encountered by military firefighters and generally by active military personal in the field of engagement, as well as by individuals participating in a wide variety of other activities with similar exposure, e.g., scuba diving, rock climbing, parachuting, etc.

One object of the invention is to provide a heat resistant sheath or scabbard for a tool having a heat resistant handle and a fixed blade and that the combination of the sheath and tool be closely and securely supported against the user's wearing apparel in the chest area, such as a firefighter's S.C.B.A. harness, military vest, etc. It is also important that the tool and sheath be secured to the user's chest area in an upside down vertical position so that the tool handle is presented in ready position for grasping by one hand. It is important to ensure that the tool is secured to the sheath in a manner so as to prevent accidental dislodgment. Still another important object is that the tool be readily removable from the sheath for use and easily restored within the sheath when no longer required. Still another object is to utilize high strength stainless steel and a unique serration design so that the tool is highly aggressive and effective in cutting through all types of materials, which may include building materials such as sheetrock and wood whereby firefighters may need to create alternative exit or entry routes by cutting through structural walls.

The blade and sheath combine to function as an easily accessible, highly aggressive cutting tool for use in confined, low visibility emergency situations whereby the user becomes entangled and trapped. This functionality is achieved whereby the user is able to disengage the tool from the sheath with one hand and without any mechanical manipulation to free the tool from the sheath, apply the aggressive tool serrations and self-extricate one's self from dangerous entanglement situations or create alternative exit or entry routes through structural walls.

### SUMMARY

In a first illustrative embodiment, is a tool consisting of high strength stainless steel, heat-resistant handles and a unique serration design so that the tool is highly aggressive and effective in cutting through all types of materials.

In a second illustrative embodiment, is a sheath consisting of heat-resistant material designed to engage the tool and secure it to a user's chest area in an upside down vertical position so that the handle portion of the tool is presented in ready position for grasping by one hand whereby the tool is readily removable from the sheath without mechanical manipulation.

### BRIEF DESCRIPTION OF THE DRAWINGS

These and other objects, features and advantages of the invention will be more readily apparent from the following detailed description in which:

FIG. 1 depicts a first illustrative embodiment as an exploded view of the entire invention.

FIG. 2 depicts a second illustrative embodiment of the entire invention;

FIG. 3 depicts a first illustrative embodiment of the tool portion of the present invention;

FIG. 4 depicts a second illustrative embodiment of the tool portion of the present invention;

FIG. 5 depicts a third illustrative embodiment of the entire invention; and

FIG. 6 depicts a fourth illustrative embodiment of the entire invention.

### DETAILED DESCRIPTION

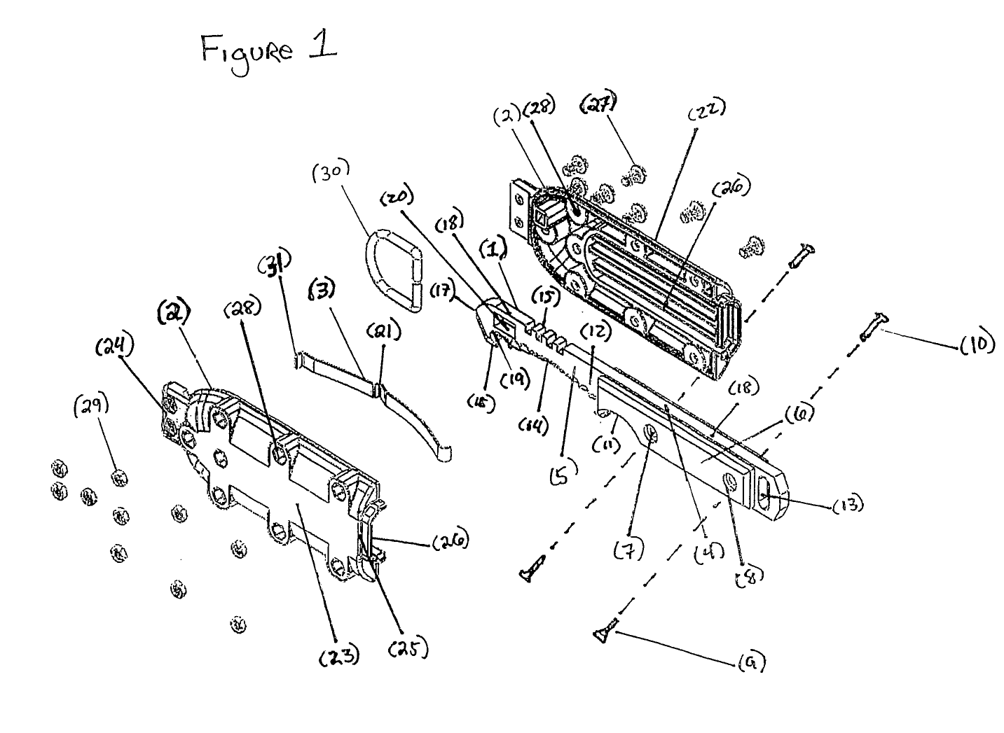

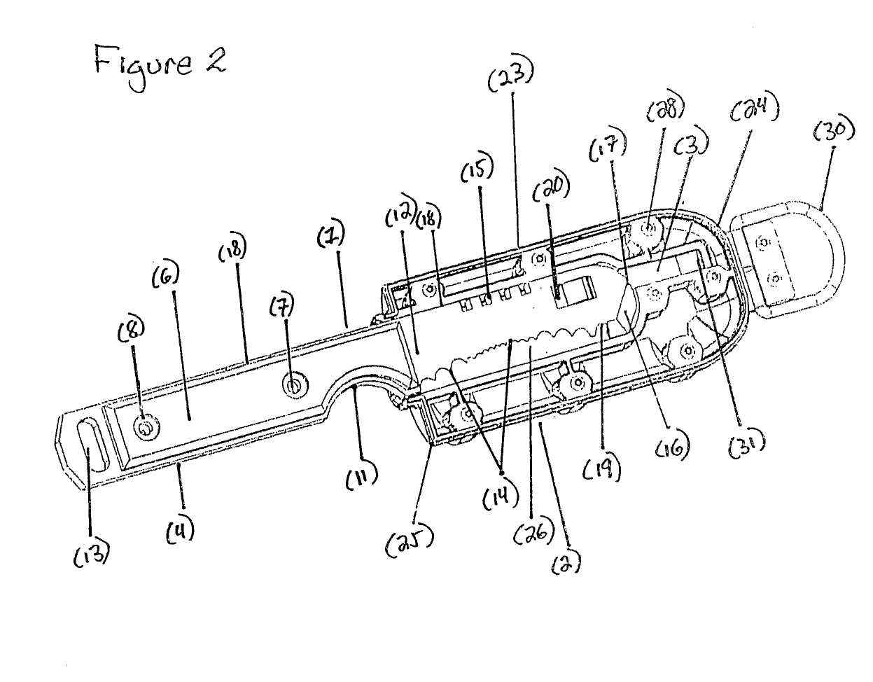

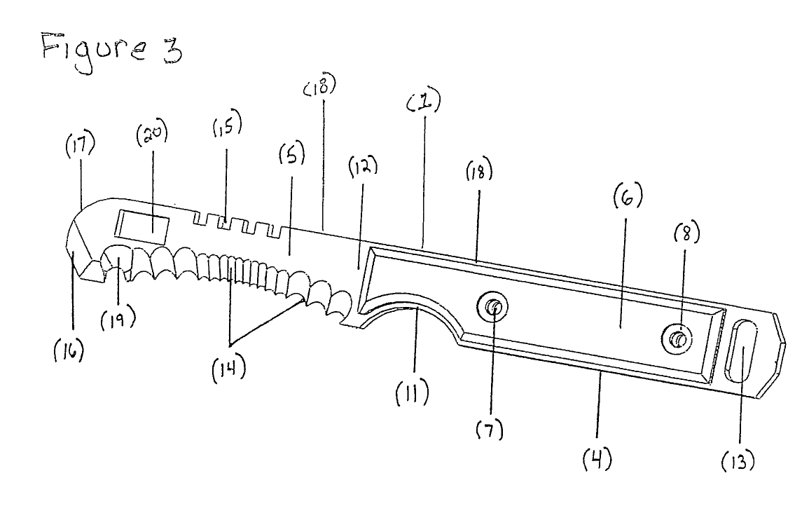

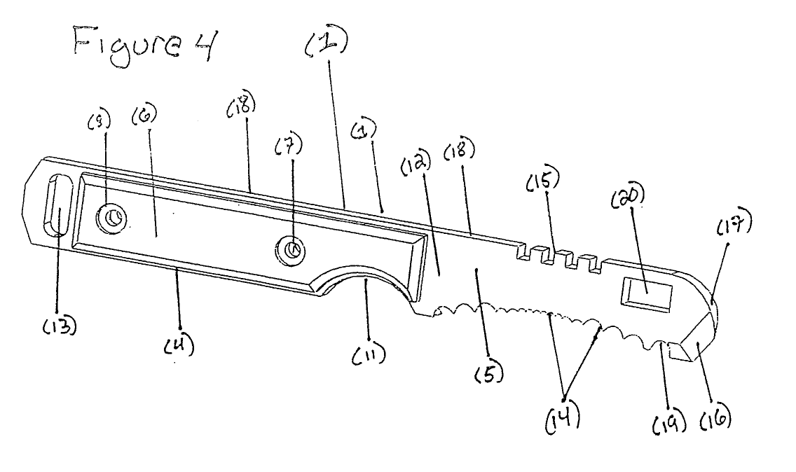

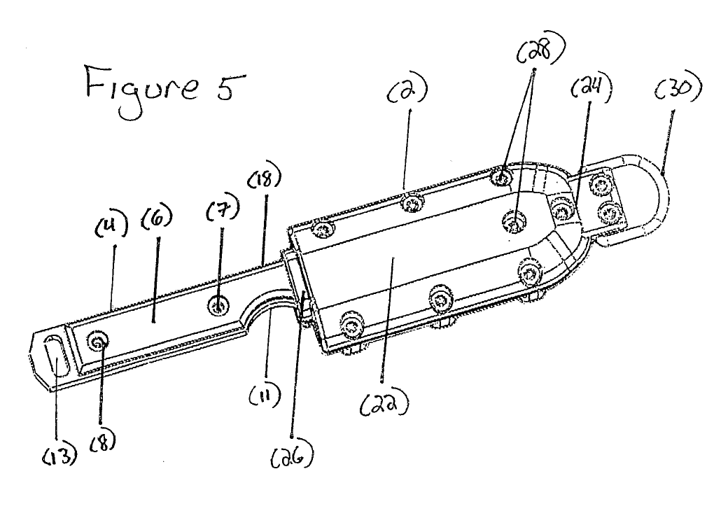

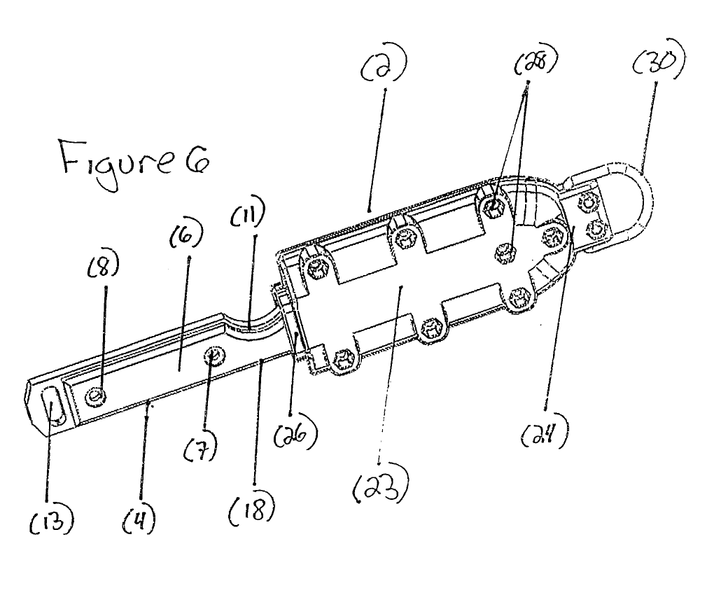

List of Components Enumerated in FIGS. 1 through 6:
(1)—Tool;
(2)—Sheath;
(3)—Sheath Retention Spring Release;
(4)—Handle Portion;
(5)—Blade Portion;
(6)—Symmetrical Rectangular Grip Covers;
(7)—Grip Receiving Openings;
(8)—Recessed Receiving Openings;
(9)—Threaded Screws;
(10)—Fasteners;
(11)—Half Circle;
(12)—Tang;
(13)—Utility Opening;
(14)—Serrations;
(15)—Thumb Grip;
(16)—Bullnose Double Flat Ground Cutting Edge;
(17)—Tip;
(18)—Spine;
(19)—Sharpened Wire-Cutting Device;
(20)—Receiving Opening;
(21)—Catch;
(22)—Front Portion;
(23)—Back Portion;
(24)—A Top Portion Including a Clasp;
(25)—Bottom Portion;
(26)—Blade Receiving Passage;
(27)—Hexagonal Threaded Screws;
(28)—Recessed Receiving Openings;
(29)—Fitted Hexagonal Nuts;
(30)—Pivoting Clasp; and
(31)—90 Degree Angle Bend

Referring to FIG. 1 of the drawings, tool and sheath combination is illustrated in an exploded view and includes a tool, generally (1), a sheath, generally (2), and a sheath retention spring release, generally (3).

Tool (1) is illustrated in FIGS. 1 through 6 and is of unitary construction with a handle portion (4) and a blade portion (5) being formed on the same piece of material. Tool is preferably constructed of high strength stainless steel.

The handle portion (4) of the tool (1) is covered on each of its sides by two symmetrical rectangular grip covers (6) preferably of heat resistant materials. The handle portion (4) of the tool (1) includes two grip receiving openings (7). The symmetrical grip covers (6) include two recessed receiving openings (8). The two symmetrical grip covers (6) are fastened to the handle portion (4) of the tool (1) by means of two threaded screws (9) and fasteners (10). Two threaded screws (9) pass through the two recessed receiving openings (8) in the first symmetrical grip cover (6), through the grip receiving openings (7) in the handle portion (4) of the tool (1) and through the second symmetrical grip cover (6) and are fastened on each side by the fasteners (10).

Handle portion (4) defines a grip that is comprised of a straight portion for being received in the palm of the hand of the user and an indentation in the shape of a half circle (11) directly below the tang (12) of the tool (1) for receipt of the user's index finger. A utility opening (13) is provided at the end of the handle portion, which can be used to tighten or loosen an oxygen bottle valve.

The blade portion (5) of the tool (1) includes serrations (14), a thumb grip (15), a bullnose double flat ground cutting edge (16) at the tip (17) of the blade portion (5) of the tool (1), a tang (12), a spine (18), a sharpened wire-cutting device (19) and a receiving opening (20).

The serrations (14) are in the shape of an arched chisel grind. The serrations (14) of the blade portion (5) consist of scalloped serrations of varying pitch and gullet sizes. The most forward serration (14) functions as a sharpened wire-cutting device (19).

The blade portion (5) proceeds on to form a bullnose double flat ground cutting edge (16) at the tip (17). The blade portion (5) of the tool (1) also includes a spine (18) consisting of two flat surface areas divided by a thumb grip (15), which is comprised of four symmetrical notches for receipt of the user's thumb finger for increased thumb and overall tool (1) grip.

The top middle of the blade portion (5) of the tool (1) consists of a receiving opening (20) in the shape of a rectangle for receiving the sheath retention spring release (3) and catch (21) located in the sheath (2) (as explained below) to fasten tool (1) to sheath (2).

Sheath (2) is illustrated in FIGS. 1, 2, 5 and 6 and includes a front portion (22), a back portion (23), a top portion including a pivoting clasp (24) and a bottom portion (25). Front and back portions (19, 20) together form a blade receiving passage (26) in which the blade portion (5) of tool (1) is received. The front and back portions (22, 23) of the sheath (2) contain nine recessed receiving openings (28). Nine hexagonal threaded screws (27) pass through the nine recessed receiving openings (28) of the front and back portions (22, 23) of the sheath (2) and are fastened by nine fitted hexagonal nuts (29) upon threaded engagement with the hexagonal threaded screws (27).

The inside of the back portion (23) of sheath (2) contains a tempered stainless steel sheath retention spring release (3). The middle of the spring release (3) consists of a catch (21) whereby the spring release (3) itself is raised and shaped to engage the receiving opening (20) of the tool (1). The spring release (3) and catch (21) are of unitary construction and are tempered such that the spring release (3) and catch (21) are flexible whereby it becomes depressed when pressure is applied. The spring release (3) and catch (21) run from the top portion (24) of the inside of the back portion (23) of the sheath (2) to the bottom portion (25) of the inside of the back portion (23) of the sheath (2). The top end of the spring release (3) is fastened to the inside of the top portion (24) of the back portion (23) of the sheath (2), which contains a bend at a 90 degree angle (31) and is inserted into a slot in the top portion (24) of the back portion (23) of the sheath (2). The spring release (3) and catch (21) run through the blade receiving passage (26).

The tool (1) is received into the sheath (2) and as it enters the blade receiving passage (26) the spring release (3) and catch (21) are depressed by the pressure of the tool (1). The bottom end of the spring release (3) consists of an unfastened rounded curve that slides back and forth in the blade receiving passage (26) when pressure is applied to the spring release (3) and catch (21) by the tool (1) during insertion and removal from the sheath (2). Once fully inserted into the blade receiving passage (26), the tool (1) is fastened to the sheath (2) by the engagement of the catch (21) into the receiving opening (20) of the tool (1). The shape of the catch (21) is designed to engage and disengage the receiving opening (20) of the tool (1) allowing the user to insert the tool (1) into the sheath (2) and remove the tool (1) from the sheath (2) with using just one hand and without any additional mechanical manipulation.

The top portion of the sheath includes a pivoting clasp (30) made of stainless steel. The pivoting clasp (30) is in the shape of a D-ring and allows for attachment to a wide variety of articles, such as a firefighter's S.C.B.A. harness, military vest, etc. The pivoting clasp (30) is fastened to the inside of the top portion (24) of the sheath (2) directly underneath the two recessed receiving openings (28) and hexagonal threaded screws and nuts (27, 29) located in the top portion (24) of sheath (2). The pivoting clasp (30) allows the sheath (2) and tool (1) to be secured to the user's chest area in an upside down vertical position so that the handle portion (4) of the tool (1) is presented in ready position for grasping by one hand whereby the tool (1) is readily removable from the sheath (2) for use and easily restored within the sheath (2) when no longer required.

What is claimed is:

1) A tool comprising:
serrations that are in the shape of an arched chisel grind and consist of individual scalloped-shaped serrations of varying pitch and gullet sizes;
a spine consisting of two flat surface areas divided by a thumb grip, which is comprised of four symmetrical notches for receipt of the user's thumb finger for increased thumb and overall tool grip and effective cutting strength; and
a receiving opening in the shape of a rectangle for receiving the sheath retention spring release and catch located in the sheath to fasten tool to sheath.

2) A sheath comprising:
a front and back portion together form a blade receiving passage in which the blade portion of tool in claim 1 is engaged and disengaged without mechanical manipulation;
slot in the top portion (24) of the back portion (23) of the sheath for receiving the 90 degree angle bend of the retention spring in claim 3; and
a pivoting clasp that allows the sheath and tool to be secured in an upside down vertical position;

3) A tempered stainless steel retention spring release comprising:
the full length of the blade receiving passage and is designed to engage the tool of claim 1;
a catch whereby the spring release itself is raised and shaped to engage the receiving opening of the tool of claim 1;
a 90 degree angle bend that inserts into the slot in the top portion of the back portion of the sheath of claim 2;
a unitary construction that is tempered such that the spring release and catch are flexible whereby the spring becomes depressed when pressure is applied from insertion of the blade portion of the tool of claim 1; and
an unfastened rounded curve that slides back and forth in the blade receiving passage when pressure is applied from insertion of the blade portion of the tool of claim 1;

4) A method for carrying a self-extrication and/or self-rescue tool consisting:
carrying a sheath and tool in an upside down vertical position so that the handle portion of the tool is presented in ready position for grasping by one hand whereby the tool is readily removable from the sheath without mechanical manipulation; and

5) A method for self-extrication and/or self-rescue consisting:
applying the blade portion of the tool, which is in the shape of an arched chisel grind and consist of scalloped serrations of varying pitch and gullet sizes, to cut through all types of materials.
